(19) United States
(12) Patent Application Publication
(10) Pub. No.: US 2011/0262744 A1
(43) Pub. Date: Oct. 27, 2011

(54) RESIN FOAM AND FOAMED MEMBER

(75) Inventors: Itsuhiro HATANAKA, Osaka (JP); Makoto SAITOU, Osaka (JP); Kazumichi KATO, Osaka (JP); Kiyoaki KODAMA, Osaka (JP)

(73) Assignee: NITTO DENKO CORPORATION, Osaka (JP)

(21) Appl. No.: 13/093,286

(22) Filed: Apr. 25, 2011

(30) Foreign Application Priority Data
Apr. 26, 2010 (JP) 2010-100819

(51) Int. Cl. B32B 7/12; C08J 9/35; C08L 23/12

(52) U.S. Cl. 428/343; 521/134; 521/97

(57) ABSTRACT

The present invention relates to a resin foam having a resin compositional homogeneity throughout the entirety from a surface to an inside thereof, having a surface with a 60° gloss value based on JIS Z 8741 (1997) of 1.5 or more, and having a 25% compressive load based on JIS K 6767 (1999) of 2.00 N/cm² or less.

### FIELD OF THE INVENTION

The present invention relates to a resin foam which is suitably usable in electric or electronic devices and is excellent in the flexibility and property of suppressing foam breakage at the peeling from a carrier tape and furthermore, exhibits excellent processability, conveyability and installability in a state of being held on a carrier tape, and a foamed member including the resin foam.

### BACKGROUND OF THE INVENTION

In general, a resin foam is punched out in a required shape according to the shape of a member used, or the surface of the resin foam is subjected to a pressure-sensitive adhesion processing so as to facilitate its fixing to a member. Representative examples of the processed shape include a window frame-like shape (for example, outer frame: 80 mm×50 mm, line width: 1 mm) where a resin foam surface is subjected to a pressure-sensitive adhesion processing. However, the resin foam subjected to such a processing is difficult to handle and for implementing efficient conveyance to a predetermined portion or highly accurate lamination to a housing, a carrier tape is used in some cases. That is, the resin foam is variously processed (e.g., punching, pressure-sensitive adhesion processing) in a state of being attached to a carrier tape and, after processing, is conveyed or installed to a device, and therefore, a high pressure-sensitive adhesive force for the carrier tape is required. On the other hand, the processed or installed resin foam must be thereafter peeled from the carrier tape.

If the pressure-sensitive adhesive force is too high for the strength of the resin foam, this may cause breakage of the resin foam when peeling the resin foam from the carrier tape.

For example, a foam with a high closed cell ratio (e.g., 80% or more) (such as foam having a smooth surface with a high closed cell ratio (Patent Document 1)) has a very little fear of breakage at the peeling, because the strength of the foam itself is very high. Similarly, a hard foam with low flexibility (for example, a foam having such flexibility that the 25% compressive load is 4.00 N/cm²) (see, Patent Document 2) also suffers very little from the fear of breakage at the peeling. However, in a flexible resin foam (for example, flexibility such that the 25% compressive load is about 1.50 N/cm²) having an interconnected cell structure or semi-interconnected semi-closed cell structure with a low closed cell ratio, which is, for example, a foam having a high expansion ratio formed through steps of impregnating a thermoplastic resin with a high-pressure inert gas (e.g., carbon dioxide in a supercritical state) and then reducing the pressure, the strength of the foam itself is low and breakage readily occurs at the peeling. Also, in the case of a foam having a high expansion ratio, a large number of pores are present in the lamination surface and a contact area with a carrier tape cannot be ensured, as a result, the pressure-sensitive adhesive force is reduced, which brings out a problem such as slippage at the processing or lamination. Particularly, in recent years, with the increase in screen size or the reduction in thickness of portable devices, demands for a foam having high flexibility are increasing, and a flexible foam capable of exhibiting high pressure-sensitive adhesive force and good peelability from a carrier tape is being required.

On the other hand, it is known to provide a resin layer on the surface of a resin foam for enhancing the adhesive property and sealing property of the resin foam. For example, there is known a foam where on either the upper or lower surface of a rubber foam having both a closed cell and an interconnected cell, a soft coat softer than the rubber foam is provided with the purpose of enhancing the sealing property (see, Patent Document 3). Also, a foam having excellent toughness, scratch resistance, abrasion resistance and the like, obtained by forming a layer composed of a thermoplastic polymer composition on the surface of a polyolefin-based resin foam and further applying a surface treating layer composed of a polar polymer onto the layer above has been proposed (see, Patent Document 4). Furthermore, a foam whose surface is treated with a polychloroprene-based adhesive composition (see, Patent Document 5), a foam having provided on the surface thereof a layer easily soluble in water (e.g., polyvinyl alcohol layer) (see, Patent Document 6), and the like have been also proposed. These are all a foam having stacked thereon a different material, and the physical properties of the foam may be changed or the production process thereof is cumbersome.
Patent Document 1: JP-A-2003-53764
Patent Document 2: JP-A-2009-221237
Patent Document 3: JP-A-9-131822
Patent Document 4: JP-A-2003-136647
Patent Document 5: JP-A-5-24143
Patent Document 6: JP-A-10-37328

### SUMMARY OF THE INVENTION

Accordingly, an object of the present invention is to provide a resin foam which is a foam excellent in the flexibility and at the same time, which can suppress or prevent breakage of the foam at the peeling from a carrier tape and has excellent processability, conveyability and installability in a state of being held on a carrier tape. Another object of the present invention is to provide a foamed member including the resin foam.

As a result of intensive studies to solve the above-described problems, the present inventors have found that a resin foam having high flexibility can be obtained by adjusting the 25% compressive load based on JIS K 6767 (1999) and when the resin foam is designed to have a resin compositional homogeneity throughout the entirety from the surface to the inside thereof and provided with a surface having a predetermined gloss value, it is ensured that the foam breakage can be suppressed or prevented, for example, at the peeling from a carrier tape and furthermore, processability, conveyability and installability in a state of being held on a carrier tape is excellent. The present invention has been accomplished based on this finding.

Namely, the present invention relates to the following items (1) to (14).

(1) A resin foam having a resin compositional homogeneity throughout the entirety from a surface to an inside thereof, having a surface with a 60° gloss value based on JIS Z 8741 (1997) of 1.5 or more, and having a 25% compressive load based on JIS K 6767 (1999) of 2.00 N/cm² or less.

(2) The resin foam according to (1), which has a surface subjected to a heat-melting treatment.

(3) The resin foam according to (1) or (2), which has an interconnected cell structure or a semi-interconnected semi-closed cell structure.

(4) The resin foam according to any one of (1) to (3), in which a resin constituting the resin foam contains a thermoplastic resin.

(5) The resin foam according to (4), in which the thermoplastic resin is a polyolefin-based resin.

(6) The resin foam according to any one of (1) to (5), which is formed through a step of impregnating a resin composition with a high-pressure gas, followed by reducing the pressure.

(7) The resin foam according to (6), in which the gas is an inert gas.

(8) The resin foam according to (7), in which the inert gas is carbon dioxide.

(9) The resin foam according to any one of (6) to (8), in which the high-pressure gas is a gas in a supercritical state.

(10) A foamed member including the resin foam according to any one of (1) to (9).

(11) The foamed member according to (10), in which the surface with a 60° gloss value based on JIS Z 8741 (1997) of 1.5 or more is exposed, and the foamed member has a pressure-sensitive adhesive layer.

(12) The foamed member according to (10) or (11), which is used in electric or electronic devices.

(13) A foamed member laminate including:

the foamed member according to any one of (10) to (12), and

a carrier tape including a substrate and a pressure-sensitive adhesive layer formed on at least one surface of the substrate,

in which the foamed member is held by the carrier tape in the form of contacting the surface of the foamed member with a 60° gloss value based on JIS Z 8741 (1997) of 1.5 or more with the pressure-sensitive adhesive layer of the carrier tape.

(14) An electric or electronic device including the foamed member according to (12).

According to the resin foam of the present invention, the 25% compressive load based on JIS K 6767 (1999) is adjusted to be not more than a specific value, so that the resin foam can have high flexibility; and at the same time, the resin foam has a resin compositional homogeneity throughout the entirety from the surface to the inside thereof and has a surface with a 60° gloss value based on JIS Z 8741 (1997) of not lower than a specific value, so that the foam breakage at the peeling from a carrier tape can be suppressed or prevented and furthermore, the foam has excellent processability, conveyability and installability in a state of being held on a carrier tape.

### DETAILED DESCRIPTION OF THE INVENTION

The resin foam of the present invention has a resin compositional homogeneity throughout the entirety from the surface to the inside thereof. The phrase “the resin foam of the present invention has a resin compositional homogeneity throughout the entirety from the surface to the inside thereof” means that the resin foam is formed using a single raw material resin composition without using two or more raw material resin compositions. Incidentally, the term “a resin compositional homogeneity” includes not only a case where the composition of the resin in the resin foam is uniform but also a case where the composition of the resin comes to have a gradient due to an unavoidable change when forming a resin foam from a single raw material resin composition. In the present specification, the “60° gloss value based on JIS Z 8741 (1997)” is sometimes simply referred to as a “60° gloss value”. Also, the “25% compressive load based on JIS K 6767 (1999)” is sometimes simply referred to as a “25% compressive load”. Furthermore, the “raw material resin composition” is sometimes simply referred to as a “resin composition”.

The resin foam of the present invention is a resin foam formed using a single raw material resin composition. For example, in the case where the resin foam of the present invention is formed using a mixed resin composition obtained by mixing two or more resin compositions, this results in formation using a single raw material resin composition and therefore, the composition of the resin is homogeneous throughout the entirety from the surface to the inside thereof.

The resin foam of the present invention is formed through foaming/molding of a resin composition. Preferably the resin foam of the present invention is formed by foaming/molding a resin composition and then applying a surface treatment thereto.

Incidentally, the raw material resin composition (resin composition) is a composition used for forming the resin foam and can be obtained by mixing a resin as the material and additives or the like which are added, if desired.

The shape of the resin foam of the present invention is not particularly limited but is preferably a sheet-like (including film-like) shape.

In the resin foam of the present invention, the 25% compressive load is 2.00 N/cm² or less, preferably 1.70 N/cm², more preferably 1.50 N/cm² or less. If the 25% compressive load of the resin foam exceeds 2.00 N/cm², the resin foam may deform the housing or member during sealing. The 25% compressive load is preferably 0.05 N/cm² or more, more preferably 0.10 N/cm² or more. In particular, when the resin foam is used for an electric or electronic device, the clearance (gap) to which the foamed member is applied is as narrow as about 0.05 to 0.75 mm in many cased and if the 25% compressive load exceeds 2.00 N/cm², the resin foam cannot follow such a clearance and may deform the housing or member at the sealing thereof.

In the resin foam of the present invention, the 25% compressive load can be adjusted, for example, (a) by selecting the kind of the thermoplastic resin (for example, selecting a resin having a Duro A hardness (JIS K 6253 (1997)) of 20 to 90) as the material of the resin foam or (b) by selecting the foaming conditions of the resin composition to give a high expansion ratio (preferably 5 times or more, more preferably 10 times or more) or form a structure with a low closed-cell structure ratio, such as semi-interconnected cell structure or interconnected cell structure. Here, the expansion ratio of the resin foam indicates a value obtained by dividing the resin density before foaming by the density (apparent density) of the resin foam.

The resin foam of the present invention has a surface having a 60° gloss value of 1.5 or more, preferably 1.6 or more, more preferably 1.7 or more. At the processing or conveyance of the resin foam of the present invention, a carrier tape is sometimes used, and the surface having a 60° gloss value of 1.5 or more is preferably laminated to the carrier tape to thereby hold the resin foam on the carrier tape. If the 60° gloss value is less than 1.5, it may become difficult to satisfy both the adherence to the carrier tape, which is required during processing or conveyance of the resin foam in a state of being held on a carrier tape, and the property of suppressing foam breakage, which is required when peeling the carrier tape after processing or conveyance. Furthermore, good installability (to smoothly peel the resin foam after processing or conveyance from the carrier tape and smoothly install it to an arbitrary site of a housing or a member; transferability) may not be exerted. Also, the resin foam of the present invention preferably has a surface having a 60° gloss value of 15 or less, preferably 10 or less. In the present specification, the “surface having a 60° gloss value of 1.5 or more” is sometimes referred to as a “specific surface”.

The gloss value on the resin foam surface is attributable to the profile on the resin foam surface and when the surface has unevenness, the gloss value becomes low because of diffuse reflection of the incident light. In other words, the surface having a low gloss value means that the surface has an uneven structure and is rough. If a resin foam having a low gloss value, that is, having an uneven structure on its surface (a resin foam with a rough surface), is laminated to a carrier tape, the adhesion area to the carrier tape is small (that is, the resin foam and the carrier tape are allowed to adhere only at points of contact), and the resin foam near the portion adhering to the carrier tape becomes very brittle. Furthermore, due to the small adhesion area to the carrier tape, the force is liable to be concentrated at the peeling from the carrier tape. For these reasons, a resin foam having a low gloss value is presumed to cause foam breakage (breakage of the resin foam, breakage of the cell wall) when peeling the resin foam from the carrier tape and readily allow attachment of its residue to the carrier tape after the peeling. On the other hand, when a resin foam having a high gloss value, that is, having a smooth surface, is laminated to a carrier tape, the adhesion area to the carrier tape becomes large (that is, the resin foam and the carrier tape are allowed to adhere by surface adhesion) and thanks to the large adhesion area to the carrier tape, the force is not concentrated at the peeling from the carrier tape. Accordingly, a resin foam having a high gloss value is estimated to hardly cause foam breakage when peeling the resin foam from the carrier tape.

The 60° gloss value on the surface of the resin foam of the present invention is adjusted, for example, by a surface treatment applied after foaming/molding the resin composition. More specifically, in the case of performing a heat-melting treatment as the surface treatment, the 60° gloss value on the surface is adjusted by selecting the treatment temperature or treatment time.

In the resin foam of the present invention, the entire surface may be the specific surface or the surface may be partially the specific surface. As described above, the resin foam of the present invention preferably has a sheet-like shape and when the resin foam of the present invention is in the form of a sheet, at least one surface is preferably the specific surface.

The cell structure of the resin foam of the present invention is not particularly limited and may be any of a closed cell structure, a semi-interconnected semi-closed cell structure (a cell structure where a closed cell structure and an interconnected cell structure are mixed, and the ratio therebetween is not particularly limited), and an interconnected cell structure. In particular, from the standpoint of obtaining good flexibility, the resin foam of the present invention preferably has a cell structure of interconnected cell structure or semi-interconnected semi-closed cell structure. Incidentally, the semi-interconnected semi-closed cell structure includes, for example, a cell structure where the ratio of the closed cell structure part in the cell structure is 40% or less, and preferably 30% or less.

The cell structure of the resin foam of the present invention can be adjusted by selecting the foaming method or foaming conditions (for example, the kind or amount of the foaming agent, or the temperature, pressure or time during the foaming) at the formation of the resin foam according to the kind of the thermoplastic resin as the material of the resin foam.

The density (apparent density) of the resin foam of the present invention may be appropriately set according to the intended use or the like but is preferably 0.20 g/cm³ or less, more preferably 0.15 g/cm³ or less, and still more preferably 0.13 g/cm³ or less. The lower limit of the density of the resin foam is preferably 0.02 g/cm³ or more, and more preferably 0.03 g/cm³ or more. If the density of the foam layer exceeds 0.20 g/cm³, the foaming may be insufficient or the flexibility may be impaired, whereas if it is less than 0.02 g/cm³, the strength of the resin foam may be significantly reduced and this is not preferred.

The density of the resin foam is determined as follows. The resin foam is punched by a punching blade of 40 mm×40 mm, and the dimension of the punched sample is measured. Also, the thickness is measured by a 1/100 dial gauge with a measuring terminal of 20 mm in diameter (φ)). From the values obtained, the volume of the resin foam is computed. Next, the weight of the resin foam is measured by an even balance having a minimum scale value of 0.01 g or more. Based on these values, the density (g/cm³) of the resin foam is computed.

In the resin foam of the present invention, the density can be adjusted by selecting the foaming method or foaming conditions (for example, the kind or amount of the foaming agent, or the temperature, pressure or time during the foaming) at the formation of the resin foam according to the kind of the thermoplastic resin as the material of the resin foam.

The resin foam of the present invention preferably has a surface layer and a foam layer. The surface layer of the resin foam of the present invention indicates the layered region of 5 to 75 μm in height from the resin foam surface and unlike the foam layer, this is a layered portion having a dense structure where cells are crushed. The foam layer of the resin foam of the present invention is a portion having a structure where cells are distributed, and this is a layered portion occupying almost the entire resin foam.

The resin foam of the present invention, when this is in the form of a sheet, may have a surface layer on both surface sides or may have a surface layer only on one surface side. Incidentally, when the resin foam of the present invention is in the form of a sheet and has a surface layer on both surface sides, the 60° gloss value on the surfaces of two surface layers may be 1.5 or more, or only the 60° gloss value on the surface of one surface layer may be 1.5 or more. In the present specification, the “surface layer with the surface having a 60° gloss value of 1.5 or more” is sometimes referred to as a “specific surface layer”.

In the case where the resin foam of the present invention is in the form of a sheet and has a surface layer and a foam layer, the specific surface layer side is preferably laminated to a carrier tape to thereby hold the resin foam on the carrier tape.

As described above, the resin foam of the present invention is sometimes processed or conveyed in a state of being held on a carrier tape by laminating the surface having a 60° gloss value of 1.5 or more (specific surface) to the carrier tape, and the behavior of the carrier tape holding the resin foam during such conveyance or processing is related to a peeling phenomenon at a low speed. Accordingly, in the resin foam of the present invention, from the standpoint of preventing, for example, partial peeling, falling or slippage from the carrier tape during processing or conveyance of the resin foam in a state of being held on the carrier tape, the pressure-sensitive adhesive force of the specific surface to a carrier tape under low-speed peeling conditions (23° C., 50% RH, tension rate: 0.3 m/min, peel angle: 180°) (low-speed peeling force) is preferably 0.30 N/20 mm or more, more preferably 0.32 N/20 mm or more.

After the resin foam of the present invention is processed or conveyed in a state of being held on a carrier tape by laminating the specific surface to the carrier tape, the resin foam is peeled from the carrier tape, and the behavior at the peeling of the resin foam from the carrier tape is related to a peeling phenomenon at a high speed. In this peeling at a high speed (high-speed peeling), the resin foam must be peeled in an interface peeling manner of peeling at the interface between the carrier tape and the specific surface of the resin foam. Also, when peeling the resin foam from the carrier tape, foam breakage must be suppressed or prevented. Furthermore, installability is also required. Accordingly, in the resin foam of the present invention, the pressure-sensitive adhesive force of the specific surface to a carrier tape under high-speed peeling conditions (23° C., 50% RH, tension rate: 10 m/min, peel angle: 180°) (high-speed peeling force) is preferably 0.25 N/20 mm or less, more preferably 0.23 N/20 mm or less, and still more preferably 0.20 N/20 mm or less.

The low-speed peeling force and high-speed peeling force of the specific surface of the resin foam of the present invention is adjusted, for example, by a surface treatment applied after the foaming/molding of the resin composition. More specifically, in the case of performing a heat-melting treatment as the surface treatment, those peeling forces are adjusted by selecting the treatment temperature or treatment time.

The thickness of the resin foam of the present invention is not particularly limited and may be appropriately selected according to the usage or the like. For example, the thickness of the resin foam can be selected from a range of 0.2 to 5 mm, and preferably from 0.3 to 3 mm.

The thermoplastic resin (thermoplastic polymer) as the material of the resin foam of the present invention is not particularly limited as long as it is a polymer exhibiting thermal plasticity and can be impregnated with a gas (cell-forming gas). That is, the resin constituting the resin foam of the present invention preferably contains a thermoplastic resin.

Examples of such a thermoplastic resin include a polyolefin-based resin such as low-density polyethylene, medium-density polyethylene, high-density polyethylene, linear low-density polyethylene, polypropylene, a copolymer of ethylene and propylene, a copolymer of ethylene or propylene with another α-olefin (e.g., butene-1, pentene-1, hexene-1,4-methylpentene-1), and a copolymer of ethylene with another ethylenically unsaturated monomer (e.g., vinyl acetate, acrylic acid, acrylic acid ester, methacrylic acid, methacrylic acid ester, vinyl alcohol); a styrene-based resin such as polystyrene and acrylonitrile-butadiene-styrene copolymer (ABS resin); a polyamide-based resin such as 6-nylon, 66-nylon and 12-nylon; polyamideimide; polyurethane; polyimide; polyetherimide; an acrylic resin such as polymethyl methacrylate; polyvinyl chloride; polyvinyl fluoride; an alkenyl aromatic resin; a polyester-based resin such as polyethylene terephthalate and polybutylene terephthalate; a polycarbonate such as bisphenol A-based polycarbonate; polyacetal; and polyphenylene sulfide. One of such thermoplastic resins may be used alone, or two or more thereof may be used in combination. In the case where the thermoplastic resin is a copolymer, the copolymer may be in either form of a random copolymer or a block copolymer.

As the thermoplastic resin, a polyolefin-based resin can be suitably used. The polyolefin-based resin used here is preferably, for example, a resin of a type having a broad molecular weight distribution and having a shoulder on the high molecular weight side, a fine crosslinked resin (a resin of a slightly crosslinked type), or a long-chain branch-type resin.

In the above-described thermoplastic resin, a rubber component and/or a thermoplastic elastomer component may be also contained. The rubber component or thermoplastic elastomer component is excellent in the flexibility and shape followability when formed into a resin foam or a foamed member, because, for example, the glass transition temperature is not more than room temperature (for example 20° C. or less).

The rubber component or thermoplastic elastomer component is not particularly limited as long as it has rubber elasticity and is foamable, and examples thereof include a natural or synthetic rubber such as natural rubber, polyisobutylene, polyisoprene, chloroprene rubber, butyl rubber and nitrile rubber, and various thermoplastic elastomers, for example, an olefin-based elastomer such as ethylene-propylene copolymer, ethylene-propylene-diene copolymer, ethylene-vinyl acetate copolymer, polybutene and chlorinated polyethylene; a styrene-based elastomer such as styrene-butadiene-styrene copolymer, styrene-isoprene-styrene copolymer and their hydrogenated additive; a polyester-based elastomer; a polyamide-based elastomer; and a polyurethane-based elastomer. One of these rubber components and thermoplastic elastomer components may be used alone, or two or more thereof may be used in combination.

Above all, an olefin-based elastomer can be suitably used as the rubber component and/or thermoplastic elastomer component. Incidentally, the olefin-based elastomer has a structure where an olefin-based resin component such as polyethylene or polypropylene and an olefin-based rubber component such as ethylene-propylene rubber or ethylene-propylene-diene rubber are microphase-peeled. This elastomer may also be of a type obtained by physically dispersing respective components or a type that is dynamically heat-treated in the presence of a crosslinking agent. Furthermore, the olefin-based elastomer has good compatibility with the polyolefin-based resin exemplified above as the thermoplastic resin.

As described above, in the resin foam of the present invention, the resin constituting the resin foam is preferably a polyolefin-based resin.

In particular, the resin foam of the present invention preferably contains such a rubber component and/or thermoplastic elastomer component together with the above-described thermoplastic resin (the thermoplastic resin excluding the rubber component or thermoplastic elastomer component). The proportion thereof is not particularly limited, but if the proportion of the rubber component and/or thermoplastic elastomer component is too small, the resin foam is liable to be reduced in the cushioning property, whereas if the proportion of the rubber component and/or thermoplastic elastomer component is excessively large, gas leakage readily occurs during the formation of the foam and it may become difficult to obtain a highly expandable foam. Therefore, for example, in the case of using the polyolefin-based resin such as polypropylene (the polyolefin-based resin excluding the olefin-based elastomer) and a polyolefin-based resin that is a mixture with the olefin-based elastomer, the mixing ratio (wt %) between the polyolefin-based resin and the olefin-based elastomer in the mixture is preferably the former/the latter=from 1/99 to 99/1, more preferably from 10/90 to 90/10, and still more preferably from 20/80 to 80/20.

In the resin foam of the invention, various additives may be blended, if desired. The kind of the additive is not particularly limited, and various additives generally used in the foam molding of a resin may be used. Specific examples thereof include a foam nucleating agent (for example, the later-described powder particle), a crystal nucleating agent, a plasticizer, a lubricant, a colorant (e.g., pigment, dye), an ultraviolet absorber, an antioxidant, an aging inhibitor, a filler, a reinforcing agent, an antistatic agent, a surfactant, a tension improver, a shrinkage inhibitor, a flowability improver, a clay, a vulcanizing agent, a surface-treating agent, and a flame retardant (for example, the later-described powdery flame retardant or a flame retardant of various forms except for powder). The amount added of the additive may be appropriately selected within the range not impairing the cell formation or the like, and an amount added usually used in the thermoplastic resin molding may be employed.

The resin foam of the present invention preferably contains a powder particle as the additive. Because, the powder particle can exert a function as a foam nucleating agent at the foam molding and therefore, by virtue of blending a powder particle, a resin foam in a good foamed state can be obtained. Examples of the powder particle which can be used include powdery talc, silica, alumina, zeolite, calcium carbonate, magnesium carbonate, barium sulfate, zinc oxide, titanium oxide, aluminum hydroxide, magnesium hydroxide, mica, clay such as montmorillonite, carbon particle, glass fiber and carbon tube. As for the powder particle, one kind may be used alone, or two or more kinds may be used in combination.

In the present invention, a powder particle having an average particle diameter (particle size) of 0.1 to 20 μm can be suitably used as the powder particle. If the average particle diameter of the powder particle is less than 0.1 μm, the particle may not sufficiently function as a nucleating agent, whereas if the particle diameter exceeds 20 μm, this may disadvantageously cause gas leakage at the foam molding.

The blending amount of the powder particle is not particularly limited but may be appropriately selected, for example, from a range of 0.1 to 150 parts by weight, preferably from 1 to 130 parts by weight, and more preferably from 2 to 50 parts by weight per 100 parts by weight of the thermoplastic resin. If the blending amount of the powder particle is less than 0.1 parts by weight, it may become difficult to obtain a uniform foam, whereas if it exceeds 150 parts by weight, not only the viscosity of the resin composition extremely rises but also gas leakage occurs at the foam molding, and the foaming characteristics may be impaired.

The resin foam of the present invention is formed of a thermoplastic resin and therefore, has a property of being readily combustible. Accordingly, in the case where a foamed member including the resin foam of the present invention is utilized for applications indispensably requiring flame retardancy, such as electric or electronic device application, it is preferred that a powder particle having flame retardancy (for example, various powdery flame retardants) is blended as the powder particle. The flame retardant can be used together with a powder particle other than a flame retardant.

The powdery flame retardant is suitably an inorganic flame retardant. The inorganic flame retardant may be, for example, a bromine-based flame retardant, a chlorine-based flame retardant, a phosphorus-based flame retardant, and an antimony-based flame retardant, but the chlorine-based flame retardant or bromine-based flame retardant generates, when fired, a gas component harmful to human body and corrosive to devices, and the phosphorus-based flame retardant or antimony-based flame retardant has a problem of harmfulness, explosiveness or the like. Therefore, a non-halogen/non-antimony-based inorganic flame retardant can be suitably used. Examples of the non-halogen/non-antimony-based inorganic flame retardant include aluminum hydroxide, magnesium hydroxide, and a hydrated metal compound such as magnesium oxide/nickel oxide hydrate and magnesium oxide/zinc oxide hydrate. The hydrated metal oxide may be surface-treated. Also, one kind of a powdery flame retardant may be used alone, or two or more kinds may be used in combination.

In the case of using such a flame retardant, the amount used thereof is not particularly limited and may be appropriately selected, for example, from a range of 5 to 130 parts by weight, and preferably from 10 to 120 parts by weight per 100 parts by weight of the thermoplastic resin. If the amount used is too small, the flame retardation effect may not be obtained, whereas if the amount used is excessively large, it may be difficult to obtain a high-expansion foam.

The resin foam of the present invention is preferably formed, as described above, by foaming/molding a resin composition and then applying a surface treatment (particularly a heat-melting treatment of the surface) thereto, more preferably by foaming/molding a resin composition to obtain a foamed structure and then applying a surface treatment (particularly a heat-melting treatment of the surface) to the foamed structure. In this preferred method, the specific surface of the resin foam may be formed when surface-treating the foamed structure. Incidentally, the foamed structure is a foam obtained by foaming/molding a resin composition and means a foam before the surface treatment is applied.

Also, as described above, the resin foam of the present invention preferably has a surface layer and a foam layer, and in this embodiment, the resin foam has, as essential constituents, a foam layer and a surface layer (specific surface layer) where the 60° gloss value on the surface is 1.5 or more. The resin foam of this embodiment is preferably formed by foaming/molding a resin composition to obtain a foamed structure and then applying a surface treatment (particularly a heat-melting treatment of the surface) to the foamed structure. In this preferred method, the specific surface or foam layer of the resin foam may be formed when surface-treating the foamed structure.

The resin foam of the present invention may be also a resin foam formed by foaming/molding a single raw material resin composition and then applying a surface treatment thereto, where the resin foam has a 25% compressive load of 2.00 N/cm² or less and has a surface with a 60° gloss value of 1.5 or more.

In the resin foam of the present invention, the foaming method used when foaming/molding a resin composition is not particularly limited, and examples thereof include usually employed methods such as physical method and chemical method. A general physical method is a method where a low boiling-point liquid (foaming agent) such as chlorofluorocarbons and hydrocarbons is dispersed in a resin and the dispersion is then heated to vaporize the foaming agent, thereby forming cells. Also, a general chemical method is a method of forming cells by using a gas generated resulting from thermal decomposition of a compound (foaming agent) added to a resin. However, in the general physical method, flammability or toxicity of a substance used as the foaming agent and an environmental effect such as ozone depletion are concerned. In the general chemical method, the foaming gas residue remains in the foam and therefore, contamination with a corrosive gas or impurities in the foaming gas becomes a problem in the electric device application highly requiring low contamination. Moreover, in either of these physical method and chemical method, a fine cell structure is difficult to form, and in particular, it is supposed to be very difficult to form a fine cell of 300 μm or less.

Therefore, in the present invention, the foaming method is preferably a method using a high-pressure gas as the foaming agent, because a foam having a small cell diameter and having a high cell density can be easily obtained. A method using a high-pressure inert gas as the foaming agent is more preferred. The inert gas means a gas inert to the resin in a resin composition. That is, the cell structure (foamed structure) of the resin foam of the present invention is preferably formed by a method using a high-pressure inert gas as the foaming agent. More specifically, the cell structure of the resin foam of the present invention is preferably formed through steps of impregnating a resin composition with a high-pressure gas and then reducing the pressure.

That is, in the resin foam of the present invention, the method for foaming/molding a resin composition by a method using a high-pressure gas as the foaming agent is preferably a method of forming the resin foam through steps of impregnating a resin composition with a high-pressure gas and then reducing the pressure, and specific preferred examples of the method include a method of forming the resin foam through steps of impregnating an unfoamed molded product composed of a resin composition with a high-pressure gas and then reducing the pressure, and a method of impregnating a melted resin composition with a gas under pressure and then performing molding while reducing the pressure.

The inert gas is not particularly limited as long as it is inert to the resin as the material of the resin foam and can impregnate the resin, and examples thereof include carbon dioxide, nitrogen gas and air. These gases may be mixed and used. Among these, carbon dioxide can be preferably used because of its large impregnating amount for resin and high impregnation rate.

Furthermore, in view of increasing the impregnation rate for a resin composition, the high-pressure gas (particularly inert gas, more particularly carbon dioxide) is preferably a gas in a supercritical state. In a supercritical state, the solubility of gas in the resin is increased to enable high-concentration mixing. Also, since high-concentration impregnation is possible, generation of cell nuclei at rapid pressure drop after impregnation is increased and despite the same porosity, the density of cells formed resulting from growth of the cell nuclei becomes high, so that fine cells can be obtained. The critical temperature of carbon dioxide is 31° C., and the critical pressure is 7.4 MPa.

In the resin foam of the present invention, the method for foaming/molding a resin composition by a method using a high-pressure gas as the foaming agent may be performed in a batch process where a resin composition is previously molded to an appropriate shape such as sheet to obtain an unfoamed resin molded body (unfoamed molded product) and this unfoamed resin molded body is impregnated with a high-pressure gas and then foamed by releasing the pressure, or may be performed in a continuous process where a resin composition is kneaded together with a high-pressure gas under pressure and molded simultaneously with release of the pressure, thereby performing molding and foaming at the same time.

In the resin foam of the present invention, when foaming/molding a resin composition in a batch process, examples of the method for forming an unfoamed resin molded body for use in the foaming include: a method of molding a resin composition by using an extruder such as single-screw extruder and twin-screw extruder; a method of uniformly kneading a resin composition by using a kneading machine equipped with a blade such as a roller-type, a cam-type, a kneader-type or Banbury-type, and pressing it to a predetermined thickness by using, for example, a press such as hot plate; and a method of molding a resin composition by using an injection molding machine. The unfoamed resin molded body may be also formed by a molding method other than extrusion molding, press molding and injection molding. The shape of the unfoamed resin molded body is not particularly limited, and various shapes may be selected according to usage, but examples of the shape include a sheet form, a roll form and a plate form. In the resin foam of the present invention, when thus foaming/molding a resin composition in a batch process, the resin composition can be molded by an appropriate method capable of yielding an unfoamed resin molded body having a desired shape or thickness.

In the resin foam of the present invention, when foaming/molding a resin composition in a batch process, the unfoamed resin molded body obtained as above is placed in a pressure vessel (high-pressure vessel), and cells are formed in the resin through a gas impregnation step of injecting (introducing) a high-pressure gas (particularly, inert gas, more particularly carbon dioxide) to impregnate the unfoamed resin molded body with the high-pressure gas, a pressure reduction step of releasing the pressure (usually to the atmospheric pressure) upon reaching sufficient impregnation with the high-pressure gas to generate cell nuclei in the resin, and, if desired (as needed), a heating step of heating the resin to grow the cell nuclei. Incidentally, the cell nuclei may be grown at room temperature without providing a heating step. After growing the cells in this way, the resin may be rapidly cooled with cold water or the like, if desired, to fix the shape. The introduction of a high-pressure gas may be performed continuously or discontinuously. As for the heating method when growing the cell nuclei, a known or commonly employed method such as water bath, oil bath, heated roll, hot-air oven, far infrared ray, near infrared ray and microwave may be used.

In the resin foam of the present invention, the foaming/molding of a resin composition in a continuous process more specifically includes foaming/molding through a kneading/impregnation step of injecting (introducing) a high-pressure gas (particularly, inert gas, more particularly carbon dioxide) to impregnate a resin composition with the high-pressure gas while kneading the resin composition by using an extruder such as single-screw extruder and twin-screw extruder, and a molding/pressure reduction step of extruding the resin composition from a die or the like provided at the tip of the extruder to release the pressure (usually to the atmospheric pressure), thereby performing molding and foaming at the same time. Also, when foaming/molding a resin composition in a continuous process, a heating step of heating the resin to grow cells may be provided, if desired. After growing the cells in this way, the resin may be rapidly cooled with cold water or the like, if desired, to fix the shape. The introduction of a high-pressure gas may be performed continuously or discontinuously. The kneading/impregnation step and the molding/pressure reduction step may also be performed using an injection molding machine or the like other than an extruder. As for the heating method when growing cell nuclei, a known or commonly employed method such as water bath, oil bath, heated roll, hot-air oven, far infrared ray, near infrared ray and microwave may be used.

In the resin foam of the present invention, the amount of the gas mixed when foaming/molding a resin composition is not particularly limited but is, for example, from 2 to 10 wt % based on the total amount of resin components in the resin composition.

In the resin foam of the present invention, the pressure at the impregnation of the unfoamed resin molded body or resin composition with a gas in the gas impregnation step in the case of foaming/molding a resin composition in a batch process or in the kneading/impregnation step in the case of a continuous process may be appropriately selected by taking into consideration the kind of the gas, the operability and the like, but, for example, when an inert gas, particularly carbon dioxide, is used as the gas, the pressure is preferably 6 MPa or more (for example, from 6 to 100 MPa), more preferably 8 MPa or more (for example, from 8 to 100 MPa). If the gas pressure is less than 6 MPa, cell growth at the foaming proceeds aggressively and the cell diameter becomes too large, which is disadvantageously liable to cause a problem such as reduction in the antidust effect. This is because when the pressure is low, the impregnating amount of gas is relatively smaller than that under high pressure and therefore, the cell nuclei-forming rate is lowered to decrease the number of cell nuclei, as a result, the gas amount per one cell is conversely increased to give an extremely large cell diameter. Also, in the pressure range less than 6 MPa, the cell diameter and cell density greatly vary only by slightly changing the impregnation pressure, and this is likely to make the control of cell diameter and cell density difficult.

In the resin foam of the present invention, the temperature at the impregnation of the unfoamed resin molded body or resin composition with a high-pressure gas in the gas impregnation step in the case of foaming/molding a resin composition in a batch process or in the kneading/impregnation step in the case of a continuous process varies depending on, for example, the kind of the gas or resin used and may be selected in a broad range, but considering the operability and the like, the temperature is, for example, from 10 to 350° C. For example, in the case of impregnating a sheet-like unfoamed resin molded body with a high-pressure gas in a batch process, the impregnation temperature is preferably from 10 to 250° C., more preferably from 40 to 240° C., still more preferably from 60 to 230° C. Also, in a continuous process, the temperature when injecting a high-pressure gas into a resin composition and kneading the resin is preferably from 60 to 350° C., more preferably from 100 to 320° C. and still more preferably from 150 to 300° C. Incidentally, in the case of using carbon dioxide as the high-pressure gas, for keeping the supercritical state thereof, the temperature at the impregnation (impregnation temperature) is preferably 32° C. or more (particularly 40° C. more).

In the resin foam of the present invention, the pressure reduction rate in the pressure reduction step when foaming/molding a resin composition in a batch process or in a continuous process is not particularly limited but in order to obtain uniform fine cells, the pressure is preferably from 5 to 300 MPa/sec. Furthermore, the heating temperature in the heating step is, for example, from 40 to 250° C., and preferably from 60 to 250° C.

In the resin foam of the present invention, when the above-described method is used at the foaming/molding of a resin composition, this is advantageous in that a high-expansion foam can be produced and a thick resin foam can be produced. For example, in the case of foaming/molding a resin composition in a continuous process, the gap of the die fitted to the tip of the extruder must be as narrow as possible (usually on the order of 0.1 to 1.0 mm) so as to keep the pressure inside the extruder in the kneading/impregnation step. Accordingly, for obtaining a thick resin foam, a resin composition extruded out through the narrow gap must be foamed at a high expansion ratio, but conventionally, since a high expansion ratio cannot be obtained, the resin foam formed is limited to those having a small thickness (for example, from 0.5 to 2.0 mm). On the other hand, when a resin composition is foamed/molded using a high-pressure gas, a resin foam having a final thickness of 0.50 to 5.00 mm can be continuously obtained.

In order to obtain such a thick resin foam, the relative density [density after foaming/density in an unfoamed state (for example, the density of the resin composition or the density of the unfoamed molded product)] is preferably from 0.02 to 0.30, and more preferably from 0.03 to 0.25. If the relative density exceeds 0.30, insufficient foaming may result or a problem may arise in terms of flexibility, whereas if it is less than 0.02, the strength of the resin foam may be extremely reduced and this is not preferred.

The relative density above can be adjusted by appropriately selecting and setting, for example, the operation conditions such as temperature, pressure and time in the gas impregnation step or the kneading/impregnation step, the operation conditions such as pressure reduction rate, temperature and pressure in the pressure reduction step or the molding/pressure reduction step, or the heating temperature in the heating step after pressure reduction or molding/pressure reduction, according to the kind of the gas, thermoplastic resin, rubber component and/or thermoplastic elastomer component, or the like used.

As described above, the resin foam of the present invention is preferably formed by foaming/molding a resin composition and then applying a surface treatment thereto, more preferably by foaming/molding a resin composition to obtain a foamed structure and then applying a surface treatment to the foamed structure, and the surface treatment is not particularly limited as long as it is possible to obtain a resin compositional homogeneity throughout the entirety from the surface to the inside of the resin foam, but a heat-melting treatment is preferred because compatibility with other materials need not be taken into consideration and the change in thickness is small.

The heat-melting treatment is not particularly limited but examples thereof include a press treatment with a heated roll, a laser irradiation treatment, a contact melting treatment on a heated roll, and a flame treatment.

In the case of a press treatment with a heated roll, the treatment can be suitably performed using a heated laminator or the like. Examples of the material for the roll include rubber, metal and fluororesin (for example, Teflon (registered trademark)).

The temperature in the heat-melting treatment is not particularly limited but is preferably not less than a temperature 15° C. lower than the softening point or melting point of the resin constituting the resin foam (more preferably not less than a temperature 12° C. lower than the softening point or melting point of the resin constituting the resin foam) and is preferably not more than a temperature 20° C. higher than the softening point or melting point of the resin constituting the resin foam (more preferably not more than a temperature 10° C. higher than the softening point or melting point of the resin constituting the resin foam). If the temperature in the heat-melting treatment is less than a temperature 15° C. lower than the softening point or melting point of the resin constituting the resin foam, melting of the resin may not proceed, whereas if the temperature in the heat-melting treatment exceeds a temperature 20° C. higher than the softening point or melting point of the resin constituting the resin foam, shrinkage of the cell structure may occur to cause a problem such as wrinkling.

The treatment time in the heat-melting treatment varies depending on the treatment temperature but is, for example, preferably from 0.1 to 10 seconds, more preferably from 0.5 to 7 seconds. If the time is too short, melting of the surface may not proceed to fail in forming the specific surface or specific surface layer or in obtaining the desired 60° gloss value, whereas if the time is excessively long, shrinkage of the foam may occur to cause a problem such as wrinkling.

The resin foam may be processed into various shapes according to the site in which the foam is used. At this time, processing, conveyance and the like of the resin foam can be performed in a state of being stuck to a carrier tape (that is, as a foamed member laminate by holding the resin foam on a carrier tape).

In particular, the resin foam of the present invention has a specific surface and therefore, even a resin foam having a high expansion ratio exhibits excellent performance in terms of processing or conveyance in a state of being held on a carrier tape by contacting the specific surface with the carrier tape and also, is excellent in the property of preventing the foam breakage at the peeling from the carrier tape after processing or conveyance as well as in the installability (transferability).

### (Foamed Member)

The foamed member of the present invention is a member including the above-described resin foam. The shape of the foamed member is not particularly limited but is preferably a sheet-like (including film-like) form. Also, the foamed member may have, for example, a configuration composed of only the resin foam or may have a configuration where another layer (particularly, a pressure-sensitive adhesive layer (a layer formed of a pressure-sensitive adhesive), a substrate layer or the like) is stacked on the resin foam.

In view of characteristics for carrier tape, such as processability or conveyability in a state of being held on a carrier tape, the property of suppressing foam breakage at the peeling from a carrier tape after processing or conveyance in a state of being held on a carrier tape, and installability, the foamed member of the present invention preferably has a surface with a 60° gloss value of 1.5 or more (specific surface). In particular, when the foamed member has a configuration where another layer is stacked on the resin foam, the specific surface is preferably exposed.

Also, the foamed member of the present invention preferably has a pressure-sensitive adhesive layer. When the foamed member has a pressure-sensitive adhesive layer, for example, a supporting board for processing can be provided on the foamed member through the pressure-sensitive adhesive layer, or the formed member can be fixed or temporarily fixed to an adherend.

The pressure-sensitive adhesive forming the pressure-sensitive adhesive layer is not particularly limited, and there may be appropriately selected and used, for example, a known pressure-sensitive adhesive such as acrylic pressure-sensitive adhesive, rubber-based pressure-sensitive adhesive (e.g., natural rubber-based pressure-sensitive adhesive, synthetic rubber-based pressure-sensitive adhesive), silicone-based pressure-sensitive adhesive, polyester-based pressure-sensitive adhesive, urethane-based pressure-sensitive adhesive, polyamide-based pressure-sensitive adhesive, epoxy-based pressure-sensitive adhesive, vinyl alkyl ether-based pressure-sensitive adhesive and fluorine-based pressure-sensitive adhesive. One kind of a pressure-sensitive adhesive may be used alone, or two or more kinds may be used in combination. Incidentally, the pressure-sensitive adhesive may be a pressure-sensitive adhesive having any form of an emulsion-type pressure-sensitive adhesive, a solvent-type pressure-sensitive adhesive, a hot melt-type pressure-sensitive adhesive, an oligomer-type pressure-sensitive adhesive, a solid-type pressure-sensitive adhesive or the like. Above all, the pressure-sensitive adhesive is preferably an acrylic pressure-sensitive adhesive in view of, for example, preventing contamination of the adherend.

The thickness of the pressure-sensitive adhesive layer is preferably from 2 to 100 μm, and more preferably from 10 to 100 μm. A thinner pressure-sensitive adhesive layer has a higher effect of preventing attachment of dirt or dust to the edge and therefore, the thickness is preferably smaller. Incidentally, the pressure-sensitive adhesive layer may have either form of a single layer or a laminate layer.

In the foamed member of the present invention, the pressure-sensitive adhesive layer may be provided through another layer (underlayer). Examples of the underlayer include another pressure-sensitive adhesive layer, an intermediate layer, an undercoating layer, and a substrate layer (particularly, a film layer, a nonwoven fabric layer or the like). Furthermore, the pressure-sensitive adhesive layer may be protected by a release film (separator) (e.g., release paper, release film).

The foamed member of the present invention may be processed to have a desired shape or thickness, for example, may be processed into various shapes according to the device, equipment, housing, member or the like used.

The foamed member of the present invention is suitably used as a member (for example, a dust-proof material, a sealing material, a shock absorber, an acoustic insulator or a buffer material) used in fitting (mounting) various members or parts in predetermined sites. In particular, the foamed member of the present invention is suitably used as a member (for example, a dust-proof material, a sealing material, a shock absorber, an acoustic insulator or a buffer material) used in fitting (mounting) parts constituting an electric or electronic device in predetermined sites.

That is, the foamed member of the present invention is suitably used for an electric or electronic device. In other words, the foamed member of the present invention may be a foamed member for electric or electronic, devices.

Various members or parts which can be fit (mounted) using the foamed member are not particularly limited, but preferred examples thereof include various members or parts in electric or electronic devices. Examples of the member or part for electric or electronic devices include optical members or optical parts such as image display member (particularly, small image display member) mounted in a display device such as liquid crystal display, electroluminescence display and plasma display, and camera or lens (particularly, small camera or lens) mounted in a so-called mobile communication device such as “cellular phone” and “mobile information terminal”.

The foamed member can also be used as a dust-proof material when preventing leakage of toner from a toner cartridge. Examples of the toner cartridge which can be fitted by utilizing the foamed member include a toner cartridge used in an image forming device such as copier and printer.

### (Foamed Member Laminate)

The foamed member laminate of the present invention includes the resin foam and a carrier tape having a pressure-sensitive adhesive layer on at least one surface of a substrate, where the foamed member is held on a carrier tape in the form of contacting the specific surface of the foamed member with the pressure-sensitive adhesive layer of the carrier tape.

In this way, the foamed member laminate has a configuration where the foamed member is stuck to the pressure-sensitive adhesive surface of the carrier tape, so that the foamed member can be, for example, processed or conveyed in a state of being stuck to the pressure-sensitive adhesive surface of the carrier tape and moreover, thanks to sticking of the specific surface to the pressure-sensitive adhesive surface of the carrier tape, the foamed member can be easily peeled from the carrier tape while suppressing or preventing foam breakage in use of the foamed member.

The carrier tape is not particularly limited, but it is important to have at least one pressure-sensitive adhesive layer and while exerting a pressure-sensitive adhesive force (adhesive force) sufficiently high to hold the foamed member (particularly, the specific surface of the foamed member) at the processing or conveyance of the foamed member, exert a pressure-sensitive adhesive force (adhesive force) low enough to allow for easy peeling without breaking the surface at the peeling of the foamed member.

Accordingly, a pressure-sensitive adhesive tape or sheet having a pressure-sensitive adhesive layer formed of various pressure-sensitive adhesives can be used as the carrier tape and in particular, from the standpoint of satisfying both adhesion and peeling, an acrylic pressure-sensitive adhesive tape or sheet having an acrylic pressure-sensitive adhesive layer formed of an acrylic pressure-sensitive adhesive containing an alkyl(meth)acrylate as the main component of the pressure-sensitive adhesive can be suitably used. Such a pressure-sensitive adhesive tape or sheet may have either configuration of a substrate-attached type pressure-sensitive adhesive tape or sheet where a pressure-sensitive adhesive layer is formed on at least one surface of a substrate, or a substrate-less type pressure-sensitive adhesive tape where only a pressure-sensitive adhesive layer is formed.

As for the pressure-sensitive adhesive forming the pressure-sensitive adhesive layer, examples of the pressure-sensitive adhesive other than an acrylic pressure-sensitive adhesive include a rubber-based pressure-sensitive adhesive (e.g., natural rubber-based pressure-sensitive adhesive, synthetic rubber-based pressure-sensitive adhesive), a silicone-based pressure-sensitive adhesive, a polyester-based pressure-sensitive adhesive, a urethane-based pressure-sensitive adhesive, a polyamide-based pressure-sensitive adhesive, an epoxy-based pressure-sensitive adhesive, a vinyl alkyl ether-based pressure-sensitive adhesive, and a fluorine-based pressure-sensitive adhesive. One kind of a pressure-sensitive adhesive may be used alone, or two or more kinds may be used in combination. The pressure-sensitive adhesive may be a pressure-sensitive adhesive having any form of an emulsion-type pressure-sensitive adhesive, a solvent-type pressure-sensitive adhesive, a hot melt-type pressure-sensitive adhesive, an oligomer-type pressure-sensitive adhesive, a solid-type pressure-sensitive adhesive or the like.

The substrate in the pressure-sensitive adhesive tape or sheet is not particularly limited, and an appropriate sheet-like substances, for example, a plastic substrate such as plastic film or sheet; a paper substrate such as paper; a fibrous substrate such as fabric, nonwoven fabric and net; a metal substrate such as metal foil and metal sheet; a rubber substrate such as rubber sheet; a foam such as foamed sheet; or a laminate thereof (particularly, a laminate of a plastic substrate and another substrate, a laminate of plastic films (or sheets), or the like), may be used.

The substrate and the pressure-sensitive adhesive layer in the pressure-sensitive adhesive tape or sheet as the carrier tape are not particularly limited in their thickness and the like.

Processing into a predetermined shape is applied to the formed member by using the foamed member laminate of the present invention and thereafter, the foamed member is peeled from the carrier tape, whereby the formed member can be isolated. The thus-isolated foamed member is peeled by the generation of peeling at the interface between the foamed member and the carrier tape, keeps a good foamed structure with almost or utterly no foam breakage of causing breakage in the foam of the foamed member, and moreover, is processed into a predetermined shape. Accordingly, the foamed member processed and isolated by using the foamed member laminate is useful as a dust-proof material, a sealing material, a shock absorber, an acoustic insulator, a buffer material or the like used when fitting (mounting) various members or parts in predetermined sites. Particularly, the foamed member can be suitably used even when mounting small members or parts in a thin product.

### (Electric or Electronic Devices)

The electric or electronic devices of the present invention include the above-described foamed member. In the electric or electronic devices, the foamed member is used, for example, as a dust-proof material, a sealing material, a shock absorber, an acoustic insulator or a buffer material. Such electric or electronic devices have a configuration where the members or parts of the electric or electronic device are fitted (mounted) in predetermined sites through the foamed member. Specifically, the electric or electronic devices include electric or electronic devices (for example, a so-called mobile communication device such as “cellular phone” and “portable information terminal”) having a configuration where an image display device such as liquid crystal display, electroluminescence display and plasma display (particularly, an image display device where a small image display member is mounted as an optical member), or a camera or lens (particularly, a small camera or lens) is mounted as an optical member or part through the resin foam or foamed member. These electric or electronic devices may be a product thinner than before and are not particularly limited in their thickness or shape.

### EXAMPLES

The present invention is described in greater detail below by referring to Examples, but the present invention is not limited to these Examples by any means.

### Production Example 1 of Resin Foam

40 Parts by weight of polypropylene [melt flow rate (MFR): 0.35 g/10 min], 55 parts by weight of a polyolefin-based elastomer [melt flow rate (MFR): 6 g/10 min, JIS Hardness A: 79°], 6 parts by weight of carbon black (“Asahi #35”, trade name, produced by Asahi Carbon Co., Ltd.), and 10 parts by weight of magnesium hydroxide (average particle diameter: 0.7 μm) as powdery flame retardant were kneaded in a twin-screw extruder manufactured by Japan Steel Works, Ltd. (JSW) at 200° C., then extruded in strand form, cooled with water, and molded into pellets. The softening point of the pellet was 155° C., and the density of the pellet was 0.95 g/cm³.

The pellets were charged into a single-screw extruder manufactured by Japan Steel Works, Ltd., and a carbon dioxide gas was injected thereinto under a pressure of 22 (19 after injection) MPa in an atmosphere of 220° C. After full saturation of carbon dioxide, the pellets were cooled to a temperature suitable for foaming and then extruded from the die to obtain a sheet-like resin foam having a semi-interconnected semi-closed cell structure.

In this resin foam, the apparent density was 0.05 g/cm³, the thickness was 2.0 mm, and the expansion ratio was 19 times. This resin foam was sliced to obtain a resin foam having a thickness of 0.6 mm (sometimes referred to as “Resin Foam A”). The 25% compressive load of Resin Foam (A) was 1.15 N/cm².

### Example 1

Resin Foam (A) was contacted with a heated roll at 149° C. for 3.0 seconds by using a dielectric heating roll (manufactured by TOKUDEN Co., Ltd.), whereby a surface heat-melting treatment was applied to one surface of Resin Foam (A). As a result, a resin foam having a surface with a 60° gloss value of 2.3 was obtained.

### Example 2

A surface heat-melting treatment was applied to one surface of Resin Foam (A) in the same manner as in Example 1 except for contacting Resin Foam (A) with the heated roll for 7.0 seconds. As a result, a resin foam having a surface with a 60° gloss value of 2.6 was obtained.

### Example 3

A surface heat-melting treatment was applied to one surface of Resin Foam (A) in the same manner as in Example 1 except for contacting Resin Foam (A) with the heated roll for 4.2 seconds. As a result, a resin foam having a surface with a 60° gloss value of 2.4 was obtained.

### Example 4

A surface heat-melting treatment was applied to one surface of Resin Foam (A) in the same manner as in Example 1 except for contacting Resin Foam (A) with the heated roll for 2.3 seconds. As a result, a resin foam having a surface with a 60° gloss value of 2.1 was obtained.

### Example 5

A surface heat-melting treatment was applied to one surface of Resin Foam (A) in the same manner as in Example 1 except for contacting Resin Foam (A) with a heated roll at 147° C. for 4.2 seconds. As a result, a resin foam having a surface with a 60° gloss value of 1.8 was obtained.

### Example 6

A surface heat-melting treatment was applied to one surface of Resin Foam (A) in the same manner as in Example 1 except for contacting Resin Foam (A) with a heated roll at 151° C. As a result, a resin foam having a surface with a 60° gloss value of 2.2 was obtained.

### Comparative Example 1

Resin Foam (A) was directly used. The 60° gloss value of the surface was 0.8.

### Comparative Example 2

A surface heat-melting treatment was applied to one surface of Resin Foam (A) in the same manner as in Example 1 except for contacting Resin Foam (A) with a heated roll at 147° C. for 3.0 seconds. As a result, a resin foam having a surface with a 60° gloss value of 1.2 was obtained.

### Comparative Example 3

A surface heat-melting treatment was applied to one surface of Resin Foam (A) in the same manner as in Example 1 except for contacting Resin Foam (A) with the heated roll for 1.4 seconds. As a result, a resin foam having a surface with a 60° gloss value of 1.3 was obtained.

### (Evaluations)

The resin foams of Examples and Comparative Examples were measured or evaluated for the pressure-sensitive adhesive force, the presence or absence of foam breakage, the surface 60° gloss value and the 25% compressive load by the following measuring methods or evaluation methods. The results obtained are shown in Table 1.

### (Pressure-Sensitive Adhesive Force)

The resin foam (20 mm (width)×120 mm (length)) after storage for 24 hours or more in an atmosphere of a temperature of 23±2° C. and a humidity of 50±5% RH (the pretreatment conditions are in accordance with JIS Z 0237 (2000)) was press-bonded to the pressure-sensitive adhesive layer surface of a carrier tape of 30 mm (width)×120 mm (length) (“SPV-AM-500”, trade name, produced by Nitto Denko Corp., a substrate-attached single-coated pressure-sensitive adhesive tape) under conditions of a 2-kg roller and one reciprocation in such a manner that the surface subjected to the surface heat-melting treatment (in Comparative Example 1, the surface heat-melting treatment was not applied and therefore, either surface may suffice) came into contact with the pressure-sensitive adhesive layer surface of the carrier tape, and then left standing for 24 hours to prepare a measurement sample.

The surface on the carrier tape substrate side of the measurement sample was fixed on a support plate (for example, a Bakelite plate having a thickness of 2 mm) through a high-power double-coated pressure-sensitive adhesive tape (“No. 500”, trade name, produced by Nitto Denko Corp.) so as not to cause lifting or peeling from the support plate at the measurement, and the force necessary for peeling the resin foam from the carrier tape was measured in an atmosphere of a temperature of 23±2° C. and a humidity of 50±5% RH under each of high-speed peeling conditions (tension rate: 10 in/min, peel angle: 180°) and low-speed peeling conditions (tension rate: 0.3 m/min, peel angle: 180°) to determine the pressure-sensitive adhesive force (N/20 mm).

A high-speed peeling tester (manufactured by Tester Sangyo Co., Ltd.) was used in the measurement under high-speed peeling conditions, and a universal tensile compression tester (“TCN-1kNB”, unit name, manufactured by Minebea Co., Ltd.) was used in the measurement under low-speed peeling conditions.

Incidentally, when the force (low-speed peeling force) necessary for peeling the resin foam from the carrier tape under low-speed peeling conditions is 0.30 N/20 mm or more, processability and conveyability in a state of being held on a carrier can be evaluated as good. Also, when the force (high-speed peeling force) necessary for peeling the resin foam from the carrier tape under high-speed peeling conditions is 0.25 N/20 mm or less, peelability and installability from a carrier tape can be evaluated as good.

### (Presence or Absence of Foam Breakage)

In the measurement above, for both cases of measurement under high-speed peeling conditions and measurement under low-speed peeling conditions, the peeling state was observed with an eye, and whether surface breakage of the resin foam was generated or not was judged.

In Table 1, when surface breakage of the resin foam was not generated, this is indicated by “Absent”, and when surface breakage of the resin foam was produced, this is indicated by “Present”.

### (60° Gloss Value of Surface)

The 60° gloss value of the resin foam surface subjected to the surface heat-melting treatment (in Comparative Example 1, the surface heat-melting treatment was not applied and therefore, either surface may suffice) was measured in accordance with JIS Z 8741 (1997).

At the measurement, a gloss meter (“Gloss Checker IG-410 for High Gloss”, unit name, manufactured by Horiba Ltd.) was used, and the gloss was measured by placing the measurement terminal perpendicularly to the flow direction.

### (25% Compressive Load)

This was measured in accordance with JIS K 6767 (1999).

Incidentally, if the 25% compressive load exceeds 2.00 N/cm², the resin foam may cause deformation of the housing or member during use as a sealing material, as a result, the resin foam can be evaluated as having no flexibility required of a sealing material.

TABLE 1

| | Surface Heat-Melting | | | 25% | Low-Speed | High-Speed | |
|---|---|---|---|---|---|---|---|
| | Treatment Conditions | | 60° | Compressive | Peeling | Peeling | |
| | Temperature | Time | Gloss | Load | Force | Force | Surface |
| | [° C.] | [sec.] | Value | [N/cm²] | [N/20 mm] | [N/20 mm] | Breakage |
| Example 1 | 149 | 3.0 | 2.3 | 1.29 | 0.31 | 0.22 | Absent |
| Example 2 | 149 | 7.0 | 2.6 | 1.35 | 0.33 | 0.22 | Absent |
| Example 3 | 149 | 4.2 | 2.4 | 1.33 | 0.32 | 0.21 | Absent |
| Example 4 | 149 | 2.3 | 2.1 | 1.29 | 0.31 | 0.19 | Absent |
| Example 5 | 147 | 4.2 | 1.8 | 1.20 | 0.30 | 0.18 | Absent |
| Example 6 | 151 | 3.0 | 2.2 | 1.35 | 0.35 | 0.20 | Absent |
| Comparative | — | — | 0.8 | 1.15 | 0.11 | 0.06 | Absent |
| Example 1 | | | | | | | |
| Comparative | 147 | 3.0 | 1.2 | 1.23 | 0.22 | 0.11 | Present |
| Example 2 | | | | | | | |
| Comparative | 149 | 1.4 | 1.3 | 1.23 | 0.23 | 0.12 | Present |
| Example 3 | | | | | | | |

With respect to the samples for measurement of Examples formed at the measurement of pressure-sensitive adhesive force, after the sample was formed and then left standing in an atmosphere of a temperature of 23±2° C. and a humidity of 50±5% RH for 24 hours, the presence or absence of “lifting/peeling” between the resin foam and the carrier tape was confirmed, as a result, the “lifting/peeling” was not produced.

As apparent from Examples and Comparative Examples, there was a tendency that as the gloss value becomes larger, the pressure-sensitive adhesive force of the carrier tape is increased (see, Table 1).

In Examples, the low-speed peeling force (pressure-sensitive adhesive force under low-speed peeling conditions) exceeds 0.30 N/20 mm and therefore, there is not caused a problem that when a foamed member (a foamed member obtained by stacking a pressure-sensitive adhesive layer on the resin foam, in which the surface fixed to a carrier tape is the surface subjected to the surface heat-melting treatment) is fixed to a carrier tape and a processing of the foamed member is performed by providing a supporting board for processing on the pressure-sensitive adhesive layer and when the foamed member after the completion of processing is intended to be installed by peeling off the supporting board for processing provided on the pressure-sensitive adhesive layer, the foamed member is peeled from the carrier tape and cannot be installed.

On the other hand, in Comparative Example 1, a surface heat-melting treatment is not applied and the pressure-sensitive adhesive force is low. It is estimated that when a foamed member (a foamed member obtained by stacking a pressure-sensitive adhesive layer on the resin foam of Comparative Example 1) is fixed to a carrier tape in the form of allowing the foam surface to come into contact therewith and a processing of the foamed member is performed by providing a supporting board for processing on the pressure-sensitive adhesive layer and when the foamed member after the completion of processing is intended to be installed by peeling off the supporting board for processing provided on the pressure-sensitive adhesive layer, the foamed member is peeled from the carrier tape between the carrier tape and the foam surface of the foamed member and its accurate transfer to a housing (accurate installation into a housing) becomes difficult.

The reason why a problem that the foamed member is peeled from the carrier tape and cannot be installed is not generated in Examples is considered because the surface roughness of the surface is reduced and the contact area with the carrier tape is increased.

Also, in Comparative Examples 2 and 3, when a foamed member (a foamed member obtained by stacking a pressure-sensitive adhesive layer on the resin foam, in which the surface fixed to a carrier tape is the surface subjected to a surface heat-melting treatment) was fixed to a carrier tape and after conveyance or processing, the foamed member was peeled from the carrier tape, a foam residue remained on the carrier tape surface and breakage of the foamed member was confirmed. It is considered that in Comparative Examples 2 and 3, although the pressure-sensitive adhesive force is increased as compared with Comparative Example 1, the surface heat-melting treatment is insufficient and the cell wall is not sufficiently smoothed by heat, as a result, attachment of a residue to the carrier tape is generated.

These results reveal that when a foam with high flexibility has a surface having a 60° gloss value based on JIS Z 8741 (1997) of 1.5 or more, both the prevention of foam breakage at the peeling from a carrier tape and the characteristics for carrier tape, such as adherence to a carrier tape, can be satisfied.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2010-100819 filed on Apr. 26, 2010, and the contents are incorporated herein by reference.

All references cited herein are incorporated by reference herein in their entirety.

Also, all the references cited herein are incorporated as a whole.

According to the resin foam of the present invention, the 25% compressive load based on JIS K 6767 (1999) is adjusted to be not more than a specific value, so that the resin foam can have high flexibility; and at the same time, the resin foam has a resin compositional homogeneity throughout the entirety from the surface to the inside thereof and has a surface with a 60° gloss value based on JIS Z 8741 (1997) of not lower than a specific value, so that the foam breakage at the peeling from a carrier tape can be suppressed or prevented and furthermore, the foam has excellent processability, conveyability and installability in a state of being held on a carrier tape.

What is claimed is:

1. A resin foam having a resin compositional homogeneity throughout the entirety from a surface to an inside thereof, having a surface with a 60° gloss value based on JIS Z 8741 (1997) of 1.5 or more, and having a 25% compressive load based on JIS K 6767 (1999) of 2.00 N/cm² or less.

2. The resin foam according to claim 1, which has a surface subjected to a heat-melting treatment.

3. The resin foam according to claim 1, which has an interconnected cell structure or a semi-interconnected semi-closed cell structure.

4. The resin foam according to claim 1, wherein a resin constituting the resin foam contains a thermoplastic resin.

5. The resin foam according to claim 4, wherein the thermoplastic resin is a polyolefin-based resin.

6. The resin foam according to claim 1, which is formed through a step of impregnating a resin composition with a high-pressure gas, followed by reducing the pressure.

7. The resin foam according to claim 6, wherein the gas is an inert gas.

8. The resin foam according to claim 7, wherein the inert gas is carbon dioxide.

9. The resin foam according to claim 6, wherein the high-pressure gas is a gas in a supercritical state.

10. A foamed member comprising the resin foam according to claim 1.

11. The foamed member according to claim 10, wherein the surface with a 60° gloss value based on JIS Z 8741 (1997) of 1.5 or more is exposed, and the foamed member has a pressure-sensitive adhesive layer.

12. The foamed member according to claim 10, which is used in electric or electronic devices.

13. A foamed member laminate comprising:
the foamed member according to claim 10, and
a carrier tape comprising a substrate and a pressure-sensitive adhesive layer formed on at least one surface of the substrate,
wherein the foamed member is held by the carrier tape in the form of contacting the surface of the foamed member with a 60° gloss value based on JIS Z 8741 (1997) of 1.5 or more with the pressure-sensitive adhesive layer of the carrier tape.

14. An electric or electronic device comprising the foamed member according to claim 12.
